(19) United States
(12) Patent Application Publication
(10) Pub. No.: US 2021/0061539 A1
(43) Pub. Date: Mar. 4, 2021

(54) MOLD INHIBITOR BAG

(71) Applicant: Purina Animal Nutrition LLC, Arden Hills, MN (US)

(72) Inventor: Michael J. Gabriel, Inver Grove Heights, MN (US)

(21) Appl. No.: 16/998,844

(22) Filed: Aug. 20, 2020

Related U.S. Application Data
(60) Provisional application No. 62/891,693, filed on Aug. 26, 2019.

(51) Int. Cl. B65D 81/28; B65D 30/08; B65D 65/42; B65B 9/00; A23K 40/25; A23K 40/20; B32B 37/15; B32B 38/00; B32B 5/02; B32B 27/12; B32B 27/08; B32B 27/32

(52) U.S. Cl. CPC B65D 81/28; B32B 2439/06; B65D 65/42; B65B 9/00; A23K 40/25; A23K 40/20; B32B 37/153; B32B 38/0004; B32B 5/024; B32B 27/12; B32B 27/08; B32B 27/32; B32B 2255/20; B32B 2255/10; B32B 2307/518; B65D 29/02

(57) ABSTRACT

Methods of producing a bag for a feed product involve providing a multi-layered substrate, which includes one or more polymers. The method also involves extruding a polymer film onto a surface of the substrate to form an elongated sheet. The polymer film can include a mold inhibitor. The method further involves slicing the elongated sheet into smaller, individual sheets and joining pairs of the individual sheets together along a periphery thereof to form the bag configured to receive the feed product. The polymer film can line the inner surface of the finished bag.

### TECHNICAL FIELD

Implementations relate to packaging materials configured to inhibit mold growth and methods of forming and using same. Particular implementations include multi-layered animal feed bags comprising calcium propionate.

### BACKGROUND

Mold growth on various feed products is a widespread problem for producers and consumers. Even feed products properly packaged according to strict industry standards can be susceptible to mold growth, especially where the feed products contain moderate to high levels of moisture. To prevent mold growth, current approaches typically involve incorporating various mold inhibitor agents directly into the feed products during production. Such approaches remain vulnerable to mold growth, however, due to the penetration of external moisture into the bags used to contain the feed and/or due to the release of moisture from within the feed itself, which may then be trapped within the bags after sealing. Pre-filling contamination of the bags may also lead to unwanted mold growth. Accordingly, improved techniques for inhibiting mold growth on feed products and other consumables are necessary.

### BRIEF DESCRIPTION OF THE DRAWINGS

FIG. 1 is a perspective view of a bag in accordance with principles of the present disclosure.

FIG. 2 is a cross-sectional side view of an embodiment of a bag material in accordance with principles of the present disclosure.

FIG. 3 is a cross-sectional side view of another embodiment of a bag material in accordance with principles of the present disclosure.

FIG. 4 is a flow diagram of a method for producing the bag material in accordance with principles of the present disclosure.

### SUMMARY

Implementations provide methods of producing a bag for a feed product. In some examples, a method involves providing a multi-layered substrate. The substrate may comprise one or more polymers. The method may also involve extruding a polymer film onto a surface of the substrate to form an elongated sheet. The polymer film can include a mold inhibitor. The method may further involve slicing the elongated sheet into smaller, individual sheets and joining pairs of the individual sheets together along a periphery thereof to form the bag configured to receive the feed product. The polymer film can line the inner surface of the finished bag.

In some examples, the multi-layered substrate can comprise a film extrudate and a fabric. A lamination extrudate can be included between the film extrudate and the fabric. In some embodiments, the film extrudate comprises biaxially-oriented polypropylene. In some examples, the fabric comprises polypropylene. In some embodiments, the fabric is woven. In some examples, the fabric is non-woven. In some embodiments, the polymer film comprises a blend of polypropylene and polyethylene.

In some examples, the method further involves integrally mixing the mold inhibitor with a material comprising the polymer film before extruding the polymer film onto the surface of the substrate. In some embodiments, the mold inhibitor comprises granular or liquid calcium propionate. In some examples, the method also involves depositing the mold inhibitor onto a surface of the polymer film to form a coating. In some embodiments, the mold inhibitor comprises propionic acid. In some examples, the polymer film comprises about 0.1 wt % to about 5 wt % of the mold inhibitor. In some embodiments, the feed product does not include the mold inhibitor or another mold inhibiting agent. In some examples, the bag is configured to contain about 5 to about 50 lbs. of the feed product. In some embodiments, the multi-layered substrate comprises a finished bag material lacking mold inhibition properties. In some examples, the feed product includes pellets or extruded nuggets for livestock, horses, deer, or domestic pets.

In accordance with embodiments of the present disclosure, a method of inhibiting mold growth within a bag for a feed product can involve adding the feed product to the bag, where the feed product is added at an elevated temperature and an elevated moisture level. The method may further involve sealing the bag containing the feed product at the elevated temperature and the elevated moisture level. The method may also involve allowing the feed product to cool and release moisture within the bag. The bag can comprise a mold inhibitor embedded within or applied to an inner layer thereof. In accordance with the method, at least three weeks after adding the feed product to the bag, no mold growth is observed within the bag.

In some examples, the mold inhibitor comprises calcium propionate. In some embodiments, the elevated temperature can range from about 80° F. to about 150° F. In some examples, the elevated moisture level ranges from about 11 wt % to about 13 wt %. In some embodiments, the feed product comprises pellets or extruded nuggets.

In accordance with embodiments of the present disclosure, a bag for a feed product can comprise a bag material formed into two or more sheets joined together to form a cavity configured to receive the feed product. Each sheet can comprise a multi-layered substrate and a polymer film. The polymer film can comprise calcium propionate and the film can line an interior surface of the cavity.

In some examples, the calcium propionate can be embedded within the polymer film. In some examples, the calcium propionate can comprise a coating adhered to a surface of the polymer film. In some examples, the bag may further include a bonding agent or carrier configured to secure the coating to the surface of the polymer film. In some embodiments, the polymer film can include an extruded blend of polypropylene and polyethylene. In some examples, the multi-layered substrate can comprise a film extrudate comprising biaxially-oriented polypropylene. The film extrudate can serve as an outermost layer of the bag material relative to the cavity. The multi-layered substrate can also include a fabric comprising woven polypropylene.

In some examples, the bag further comprises an adhesive lamination extrudate positioned between the film extrudate and the fabric. In some embodiments, the bag material lacks a mold inhibiting agent. In some examples, the polymer film comprises about 0.1 wt % to about 5 wt % of the calcium propionate.

### DETAILED DESCRIPTION

Disclosed are bags or pouches having mold inhibition properties, and methods of their production and use. The material comprising the bags contains a mold inhibitor or antimycotic agent, such as calcium propionate. By adding the mold inhibitor directly to the bag material, incorporation of the inhibitor into the bag contents, e.g., animal feed products, may be reduced or even eliminated. The bag material can include multiple discrete layers, each layer comprising one or more polymers. As provided herein, the mold inhibitor is not naturally present in the polymer(s), but is integrally mixed with or coated thereon, for example via a film extrudate. Including the mold inhibitor within the bag material instead of or in addition to the contents held therein can significantly enhance mold inhibition in a manner not previously contemplated. For example, preexisting approaches for inhibiting mold growth often rely on incorporating a mold inhibition agent or preservative directly within a feed product, e.g., as a feed additive. Such approaches may be utilized in an attempt to protect each feed particle from mold growth, and may be rooted in the common understanding that mold can be effectively inhibited only by including a mold inhibition agent directly within a feed product. The disclosed approaches may accomplish the same or even greater level of mold inhibition without incorporating a mold inhibitor within the feed products, which may improve palatability of the feed products and/or allow a wider assortment of feed products to be included within the same or similar bags, e.g., feed products containing or lacking a mold inhibition agent.

The bags described herein may be configured for holding large amounts of animal feed, e.g., >20 lbs., but are not limited to such applications. For example, the bag contents may vary, and may include pelleted or extruded animal feed products, products for human consumption, or non-food products susceptible to mold and mildew growth, just to name a few.

The specific mold inhibitor incorporated into the bag material may also vary. For ease of illustration, calcium propionate is disclosed in accordance with the examples described herein. At least one additional mold inhibitor agent may be utilized, or the calcium propionate may serve as the only mold inhibitor included in the bag material.

### Bag Compositions

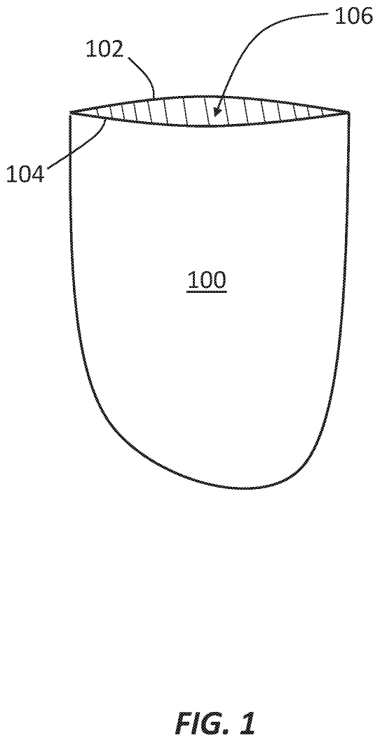

The bags disclosed herein may comprise sheets of a multi-layered bag material that includes calcium propionate, which may be trapped or embedded in, or applied to, at least one layer of the bag material. One or more layers may comprise a woven or non-woven fabric, and each layer can comprise a distinct composition, which may include a combination of one or more polymers. One or more coatings may line the innermost portion of the bag material to prevent seepage of various substances present on or within the bag contents, e.g., molasses, oil or water. The multi-layered bag material can be produced in flat sheets or films. As shown in FIG. 1, equally sized sheets 102, 104 can be joined at their periphery to form a bag 100 defining an internal volume 106.

The innermost layer of the bag material, relative to the contents held within the bag, may comprise a film extrudate formed from polymer resin. The number and type of polymers included within the innermost layer may vary. For example, the innermost layer may comprise polypropylene, polyethylene, or a blend of polypropylene and polyethylene. Additional components, for example various additives, can also be included.

The innermost layer may contain or be coupled with calcium propionate. For example, in some embodiments the calcium propionate may be embedded within the innermost layer. Granular forms of calcium propionate may remain in original form, while liquid forms of calcium propionate (propionic acid) may dry after inclusion within the innermost layer. Regardless of form, the calcium propionate may be integrally mixed with the material comprising the innermost layer during production, i.e., before the material is extruded and applied to the other bag material layers. In specific examples, the calcium propionate may be incorporated into the compounding of the polymer resin prior to film extrusion coating of the bag material. Combining the calcium propionate with the polymer resin used to form the film extrudate may ensure homogenous mixing of the two components, such that all portions of the bag material exhibit consistent mold inhibition.

In addition or alternatively, the calcium propionate may be deposited as a coating on the inside surface of the innermost layer after its extrusion. According to such examples, a liquid form of calcium propionate may be used, e.g., propionic acid, which can be applied to the innermost layer of extrudate by spray coating or rolling. A calcium propionate coating may provide an additional sealant to prevent the seepage of various liquids, e.g., oil, from the bag contents into the remaining layers of the bag material, where such substances can cause structural damage to the bag. An adhesive, a carrier, and/or a bonding agent can be used to ensure prolonged attachment of the calcium propionate coating to the innermost layer. The bonding agent can be integrally mixed with the liquid calcium propionate before its application to the innermost layer of the bag material, or the bonding agent can be applied between the innermost layer and the calcium propionate coating.

The amount of calcium propionate deposited on, or embedded within, the innermost layer may vary, along with the concentration of the calcium propionate source. In various embodiments, the calcium propionate concentration within the innermost layer may range from about 0.1 to about 5 wt %, about 0.2 to about 3 wt %, about 0.3 to about 2 wt %, about 0.4 to about 1 wt %, about 0.5 to about 0.9 wt %, about 0.6 to about 0.8 wt %, or about 0.7 wt % based on the weight of the innermost layer.

The outermost layer of the bag, again relative to the contents held therein, may comprise a polypropylene extrudate, which may be biaxially oriented. To facilitate printing of various product labels thereon, e.g., product name, nutritional information and/or graphics, particular embodiments of the outermost layer of the bag may comprise a flexographic, reverse-printed, biaxially-oriented polypropylene (“BOPP”) film extrusion. The term “biaxially-oriented” as used herein may refer to bag material, e.g., polypropylene, which has been elongated or stretch-oriented in two directions at elevated temperatures followed by being “set” in the elongated configuration by cooling the material while substantially retaining the elongated dimensions. Stretching the material in this manner can provide a relatively thin, flat surface ideal for printing. In some examples, the outermost layer of the bag also includes calcium propionate, which can be admixed with the extrusion materials prior to extrusion, or applied to the extrudate after extrusion.

The outermost layer of the bag may be positioned adjacent to a fabric layer, positioned between the outermost and innermost layers, which can comprise woven or non-woven polypropylene in various embodiments. The fabric may include one or more materials in addition to or instead of polypropylene. For instance, the fabric may comprise high-density or ultra-high-density polyethylene. Together, the outermost layer and the fabric can be resistant to abrasive and puncture forces commonly exerted against the bags disclosed herein, for example during shipping and handling. A woven fabric layer may be stronger and more durable than a non-woven fabric layer. The woven fabric may comprise at least two threads, the “warp” and “weft” threads, interlaced at 90° perpendicular angles. The number of warp and weft threads included per weave may vary and may be equal, thereby creating a square pattern, such that the woven fabric comprises 4.9 threads per weave, 5 threads per weave, 7.5 threads per weave, or 10 threads per weave, for example.

In some examples, the fabric layer may include calcium propionate in addition to or instead of one or more other layers of the bag. According to such embodiments, the calcium propionate may be present as an internal and/or external coating, or as an integral component of the fabric threads. Calcium propionate present on or within the fabric layer may reduce the amount of moisture-derived bacteria passing through the fabric.

In some examples, the outermost layer may be laminated directly to the fabric layer. Such examples may include an additional layer sandwiched between the outermost layer and the fabric layer. This additional layer, which may be referred to as a “tie layer,” can comprise an adhesive lamination extrudate configured to prevent delamination of the outermost layer from the fabric. The tie layer can include one or more components also comprising the outermost and/or fabric layers. An additional tie layer may be included between the fabric layer and the innermost layer in some examples, thereby providing additional adhesion. The total number of tie layers may increase with increasing film layers. One or more tie layers may also include an amount of calcium propionate to enhance the mold inhibition properties of the bag.

Examples may also include one or more slip agents incorporated into at least one layer of the bag material. The slip agent may reduce inter-layer friction, which can enhance the integrity of the bag material during and after production. Slip agents may include various fluoroelastomers, silicates and/or amides.

Particular embodiments of the bag material can include two, three, four, five, six or more layers. As described above, the bag material may comprise various coextruded polymers, including an outermost layer and an innermost layer (relative to the bag contents) and at least one layer sandwiched therebetween.

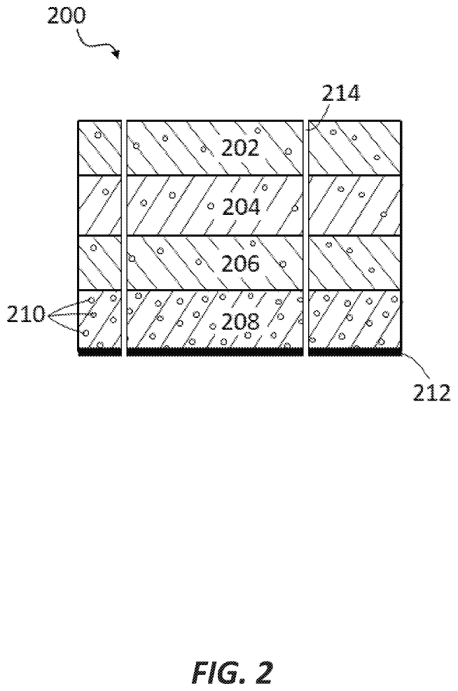

FIG. 2 is a cross-sectional side view of one example of a bag material 200. As shown, this particular embodiment includes four layers. The outermost layer 202 may comprise biaxially-oriented polypropylene. Moving inward, the second layer 204 may comprise an adhesive laminate extrudate sandwiched between the outermost layer 202 and a fabric layer 206. The second layer 204 can be configured to couple the outermost layer 202 to the fabric layer 206, preventing delamination of the two components. The fabric layer 206 may comprise a woven fabric, which may bestow the bag material with the majority of its overall strength. The fourth, innermost layer 208 may include yet another extrudate or film, which may comprise a blend of polypropylene and polyethylene. As further shown, the innermost layer 208 may further contain granular calcium propionate 210, the size of which is enlarged for illustration purposes. When included within the innermost layer 208, the calcium propionate may be granular, as shown for illustration in FIG. 2. The calcium propionate may also or alternatively be included as a molten resin or liquid solution within the material(s) constituting the innermost layer 208, such that the calcium propionate is visually indistinguishable and/or inseparable from such material(s). Regardless of its physical form, the calcium propionate may also be incorporated within one or more additional layers, such as layer 202, 204 and/or 206. In addition or alternatively, the innermost layer 208 may provide a scaffold or substrate for the calcium propionate, such that the calcium propionate may comprise a separate, inner coating 212. The embedded calcium propionate 210 may be included together with the calcium propionate inner coating 212 to maximize mold inhibition. Alternatively, either the embedded or coated calcium propionate may be sufficient to effectively inhibit mold growth. The multi-layered arrangement shown in FIG. 2 may be uniquely configured to prevent the seepage of oils, fats and other liquid substances into the woven fabric layer 206, where such substances can penetrate and expand, thereby compromising the integrity of the fabric layer and the bag material as a whole. For instance, one or more of the outermost layer 202, second layer 204, the innermost layer 208 or the inner coating 212 may be resistant to breakdown by oils, fats and other liquid substances, thereby preventing their contact with the fabric layer.

One or more perforations 214 may also be included within the bag material. The bag material disclosed herein may thus be continuous, or alternatively, may have structural modifications such as perforations, through-holes and/or slits. The optional perforations may improve the breathability of the bag, for example by providing a ventilation route for condensation produced upon cooling the feed products sealed within the bag. In this manner, the perforations can release moisture otherwise trapped within the bag while also expediting the cooling and drying process. In various embodiments, the perforations may be defined by the innermost layer of the bag material, only. In some embodiments, the perforations may extend through each layer. In yet additional embodiments, the perforations may extend through each layer except the fabric layer. According to such embodiments, the needle or similar device used to perforate the bag may pierce through each bag layer, but slide between the threads of the fabric layer, thereby improving the breathability of the bag without compromising the integrity of the fabric.

In some examples, the number and/or size of the perforations may be reduced due to the inclusion of calcium propionate in the bag material. According to such examples, the mold inhibition achieved via the calcium propionate may advantageously eliminate the need to reduce the moisture content of the feed product. In addition to simplifying the bag production process, such examples may allow feed products having higher moisture levels to be included in the bags, and/or may allow feed products to be stored within the bags for longer periods of time relative to preexisting bags lacking calcium propionate. The number of perforations included within such bags may be reduced by at least 5%, 10%, 20%, 30%, 40%, 50%, 60%, 70%, 80%, 90%, 95% or more relative to preexisting bags lacking calcium propionate.

The effectiveness of calcium propionate may also be enhanced by including perforations to reduce moisture within the bag. According to such embodiments, the inhibitory effect of calcium propionate may be achieved primarily by direct contact with the feed product inside the bag. By inhibiting mold growth via the combination of moisture reduction and direct mold inhibition, such embodiments may also allow the loading of high-moisture feed products that may not be suitable for inclusion within preexisting bags lacking calcium propionate. Such embodiments may also allow feed products, e.g., low-, moderate- and/or high-moisture feed products, to be contained within the bags for longer periods of time and/or in warmer, more humid conditions relative to preexisting bags lacking calcium propionate.

In alternative embodiments, the inclusion of perforations may decrease the effectiveness of calcium propionate. According to such embodiments, the calcium propionate may exert a mold inhibitory effect by creating an atmospheric environment within the bag that is not conducive to mold growth. By allowing air to escape, the inclusion of perforations in such embodiments may therefore disrupt or dilute the anti-mold environment within the bag. The mode of action of the calcium propionate may depend on various factors, including the manner by which it is applied to the bag material and/or its concentration within the bag material. For example, an inner coating of calcium propionate may exert mold inhibition properties by direct contact with the feed product, while calcium propionate embedded within one or more layers may exert mold inhibition properties by generating an anti-mold atmospheric environment. Moderate to high concentrations of calcium propionate may exert mold inhibition properties by direct contact and/or by generating an anti-mold atmospheric environment. Accordingly, the bags disclosed herein may include no perforations, a reduced number and/or size of perforations, or the same number of perforations relative to bags without mold inhibitor agents. In at least one or all embodiments, the inclusion of calcium propionate can significantly improve the mold inhibition properties of the disclosed bags, enabling a larger variety of feed products to be packaged within the bags for a longer period of time and/or under a wider range of environmental conditions.

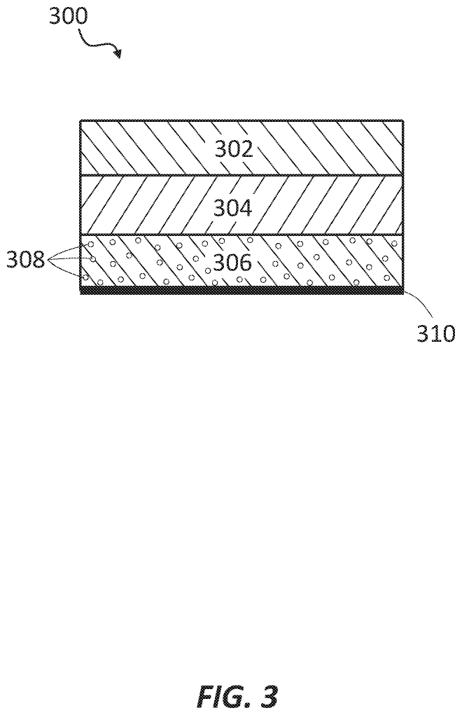

FIG. 3 is a cross-sectional side view of another example of a bag material 300, this time comprising three distinct layers. Together, the layers shown in FIG. 3 may constitute a poly-laminate film. In some embodiments, the outermost layer 302 may comprise biaxially-oriented polypropylene, and the second layer may comprise a non-woven fabric layer 304. The innermost layer 306 may provide a sealant layer comprising one or more polymers, such as ethylene-vinyl acetate or the like. As shown, calcium propionate 308 may be incorporated into the innermost layer 306 or deposited as a coating 310 on an inner surface of the innermost layer 306.

The bags may be configured to contain various amounts of fill. For example, a bag may be configured to contain feed products weighing from about 5 to about 75 lbs., about 10 to about 65 lbs., about 15 to about 55 lbs., about 20 to about 45 lbs., or about 25 to about 35 lbs. The total weight of the bag contents may dictate the required bag strength. The total strength of the bag may vary, ranging from about 80 to about 150 gsm (grams per square meter), about 90 to about 140 gsm, or about 100 to about 130 gsm. The strength can vary based on the number of layers comprising an individual sheet of bag material and the contents of each layer. In specific examples, the strength of a woven fabric layer, alone, may range from about 50 to about 80 gsm, about 55 to about 75 gsm, or about 60 to about 70 gsm.

### Methods of Production

The bag material of the present disclosure may be produced by extruding a film containing calcium propionate directly onto a substrate. In addition or alternatively, the bag material may be produced by depositing a coating of liquid calcium propionate, which may or may not be applied together with a carrier and/or bonding agent, to the substrate. In addition or alternatively, the bag material may be produced by incorporating calcium propionate within or on a substrate. The substrate may comprise one or more layers of polymers, fabric, laminates, and/or various additives (e.g., layers 202-206 of FIG. 2) which may together constitute a finished bag material, albeit lacking mold inhibition properties. Accordingly, methods of production may involve converting a pre-formed bag material into a mold-inhibiting bag material by adding a calcium propionate extrudate or coating thereto, or producing a bag material that includes calcium propionate within or on one or more layers thereof. As described above, the calcium propionate layer can be added to the inside of the substrate, relative to the feed components. The substrate may be formed concurrently with or prior to formation of the calcium propionate extrudate and/or coating.

The bag material, or at least the substrate thereof, may be produced by a cast extrusion or blown extrusion process, which may involve extruding molten polymer resin into a continuous tube. One or more layers, such as an adhesive laminate extrudate (e.g., layer 204) or the innermost layer containing calcium propionate (e.g., 208), can be applied via a rolling apparatus. In some examples, multiple extruders may be used in addition to the rolling apparatus, thereby allowing separate extrusion of distinct bag material layers. Embodiments may also involve coextrusion of multiple layers using the same extruder apparatus, again in conjunction with a rolling apparatus. Such methods may generally involve introducing the resins and any additives, e.g., calcium propionate or slip agents, to an extruder, where the resins are melt plastified by heating and then transferred to an extrusion (or coextrusion) die for formation into a tube. Embodiments may involve extruding a polymer resin containing calcium propionate directly onto a multi-layered substrate. Extruder and die temperatures may depend on the particular components used to form the bag material.

The components may be prepared from a compounding process, which involves melting one or more of the polymers and incorporating one or more additional components, including additives such as calcium propionate. The form of the calcium propionate upon compounding may vary. For example, the calcium propionate can be provided in granular or liquid form. The concentration of the calcium propionate added to the resin may also vary. For example, the addition of 2 wt % calcium propionate to a PP/PE resin blend may yield an extruded film layer comprising about 0.7 wt % calcium propionate. In embodiments, the concentration of calcium propionate within the resin used to form the film extrudate may range from about 0.1 to about 5 wt %, about 0.2 to about 4 wt %, about 0.3 to about 3.5 wt %, about 0.4 to about 3 wt %, about 0.5 to about 2.5 wt %, about 0.6 to about 2 wt %, about 0.7 to about 1.5 wt %, about 0.8 to about 1 wt %, about 1.5 to about 2.5 wt %, about 1.8 wt % to about 2.2 wt %, or about 1.9 to about 2.1 wt %.

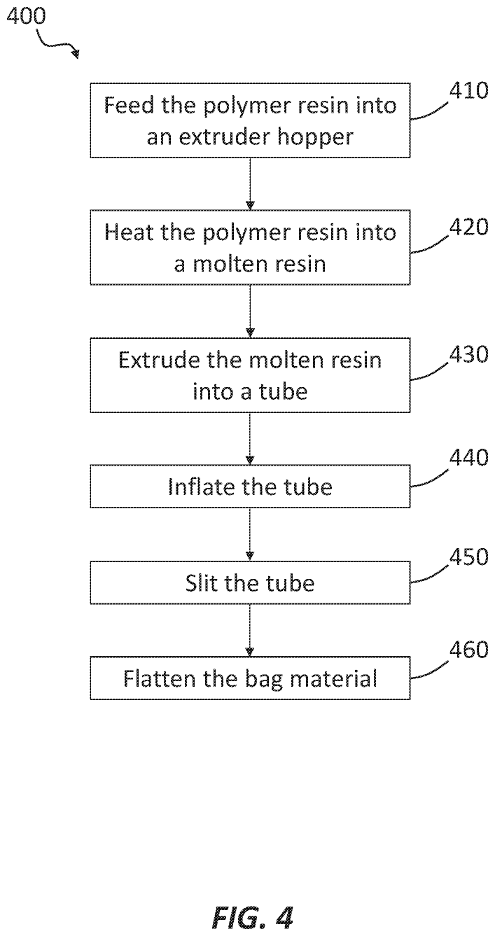

FIG. 4 illustrates a flow diagram of an example method 400 for producing a film extrudate having a mold inhibitor, e.g., calcium propionate, incorporated therein, according to certain implementations. As shown, one or more polymer resins, which may be in pellet form, can be fed into a hopper of an extruder 410. Resin pellets compounded or added concurrently with granular calcium propionate, propionic acid, and/or an aqueous calcium propionate solution, for example, can be fed into the hopper at selected rates to ensure a correct ratio of components is present for the final product. The pellets undergo mixing to generate a homogenous mixture. The homogenous mixture may then be heated into a molten resin (420). The mixture may then be passed through an extruder, where friction and heat generated by the extruder causes the pellets to melt and the molten contents to be forced through a die to form a tube (430). The tube may be inflated (440), for instance, to increase its diameter. During the step of inflation, the tube may be drawn away from the die by, for instance, a top nip roller. The tube, sometimes referred to as a “bubble,” may be slit (450) and then opened. The opened tube of blown bag material may then be flattened (460) by collapsing frames. The film may be drawn through nip rolls, over idler rolls and/or provided to a winder to produce a finished roll of calcium propionate extrudate, which may then be applied to the inside surface of a substrate. Together, the calcium propionate extrudate and the substrate may constitute a multi-layered bag material configured to inhibit mold growth.

Examples may also involve spray coating and/or rolling a solution or resin of calcium propionate and/or propionic acid onto an inner layer of a bag material. The resulting inner coating may replace or supplement calcium propionate integrated within one or more layers of the bag material. Additional or alternative examples may involve lacing or coating calcium propionate or propionic acid within the threads used to form one or more fabric layers of a bag material, e.g., fabric layer 206 shown in FIG. 2.

### Methods of Use

The bags of the present disclosure can be filled and sealed with various contents, which may then be shipped and stored for prolonged periods of time. For ease of illustration, animal feed is disclosed in accordance with the examples described herein. The animal feed can include feed formulated for livestock, horses, deer, or domestic pets, among others. The form of the animal feed may also vary, including pellets, cubes, nuggets, etc. and may be an extruded animal feed product.

Animal feed can be added to the bags immediately after production of the feed, or after a short cooling period. Accordingly, the feed may be warm or even hot at the moment it is deposited within each bag. For example, in some embodiments, the feed may be at a temperature ranging from about 120 to about 200° F., about 130 to about 190° F., about 140 to about 180° F., or about 150 to about 170° F. immediately after its production. In a particular example, the feed exits a mill or extruder at these temperatures and is deposited into the bag. The feed may optionally be cooled prior to its addition to each bag. Depending on the cooling processes used, e.g., active cooling or simply air drying, the feed temperature may be reduced to about 10 to about 15° F. below the ambient temperature of the packaging facility. Accordingly, feed produced in ambient conditions of about 100° F. may be cooled to a temperature of about 85 to about 90° F. before packaging. In some instances, the cooling period may be about 1-5 minutes, and while the animal feed may cool naturally, it continues to be at an elevated temperature relative to ambient conditions.

The animal feed at the time of depositing into the bag may also contain substantial moisture levels, which can be released as the feed cools. In some examples, the feed may contain moisture levels at the time of filling that range from about 5 to about 20 wt %, about 7 to about 18 wt %, about 9 to about 16 wt %, or about 11 to about 13 wt %. The as-filled moisture content may drop over time as the feed products cool, for example by about 1 to about 10 wt %, or any level therebetween. As a result, condensation may form within the bags, increasing the likelihood of mold growth and spoilage. The disclosed bags, however, may prevent or at least reduce such mold growth due to the inclusion of calcium propionate within or adjacent to the innermost layer of the material comprising the bags. In addition to avoiding the need to include a mold inhibitor within or on the animal feed itself, the bags may thus increase the production speed of the animal feed by eliminating the need to cool or dry the feed for extended periods of time prior to its deposition within the bags. The disclosed bags may also inhibit mold growth more effectively than bags lacking calcium propionate, even if a mold inhibitor is included within or on the feed product. Accordingly, the animal feed may be free of mold inhibitors such as calcium propionate or propionic acid or such components may be present in the animal feed in an amount or in a form that is insufficient to serve as a mold inhibitor. For instance, where a feed component such as a nutrient, vitamin or mineral is present in the animal feed where the component may also be considered a mold inhibitor, such feed component is present or in a form that does not serve as a mold inhibitor or that would be ineffective for mold inhibition (e.g., is present in an amount that is ineffective as a mold inhibitor).

The bags described herein may be especially advantageous for preventing mold growth on larger feed products, such as range cubes having a diameter of up to about 1.3125 inches, which may harbor more moisture and take longer to cool, and on feed products stored at elevated temperatures (e.g., >80° F.) and/or moisture levels (e.g., >80%). Such conditions may accelerate or otherwise increase the likelihood of mold growth. The size of the feed products held within the bags disclosed herein may vary. For example, the diameter of individual feed pellets or cubes can range from about 0.1 to about 3 inches, about 0.25 to about 2.5 inches, about 0.5 to about 2 inches, about 0.75 to about 1.75 inches, about 1 to about 1.5 inches, about 1.25 to about 1.4 inches, or about 1.5 inches, about 1.4 inches, about 1.3 inches, about 1.2 inches, about 1.1 inches, about 1 inch, or less than 1 inch, or greater than 3 inches.

### EXAMPLES

### Product Trial 1

This product trial was conducted to evaluate the mold inhibition properties of the bag material described herein. Small pouches comprising the bag material of the present disclosure were formed. The first group of test pouches comprised a bag material having a polypropylene/polyethylene innermost layer and embedded calcium propionate. The second group of test pouches comprised a bag material in which a calcium propionate coating was deposited on the inner surface of the innermost layer, which was again comprised of a polypropylene/polyethylene extrudate. A control group of pouches included the same bag material as the test groups, but without the calcium propionate embedded within or applied to a surface of the innermost layer.

Animal feed product comprising cubed cattle feed was ground to a reduced size and deposited within each of the pouches. At the time of filling, the feed contained about 90 to about 95 wt % dry matter. The filled pouches were then sealed and placed in a chamber harboring conditions favorable for accelerated mold growth. Such conditions included elevated temperature (32° C. (89.6° F.)) and humidity (>80%).

After three weeks in the chamber, all of the control pouches had visible mold growth, while none of the calcium propionate test pouches included visible mold growth. Accordingly, the test pouches effectively inhibited mold growth. The environmental conditions maintained within the chamber over the trial period may reflect typical ambient conditions at various animal feed production and packaging plants.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or components used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A method of producing a bag for a feed product, the method comprising:
providing a multi-layered substrate, the substrate comprising one or more polymers;
extruding a polymer film onto a surface of the substrate to form an elongated sheet, wherein the polymer film includes a mold inhibitor;
slicing the elongated sheet into smaller, individual sheets; and
joining pairs of the individual sheets together along a periphery thereof to form the bag configured to receive the feed product, wherein the polymer film lines an inner surface of the bag.

2. The method of claim 1, wherein the multi-layered substrate comprises:
a film extrudate; and
a fabric.

3. The method of claim 2, further comprising a lamination extrudate between the film extrudate and the fabric.

4. The method of claim 1, further comprising integrally mixing the mold inhibitor with a material comprising the polymer film before extruding the polymer film onto the surface of the substrate.

5. The method of claim 4, wherein the mold inhibitor comprises granular or liquid calcium propionate.

6. The method of claim 1, further comprising depositing the mold inhibitor onto a surface of the polymer film to form a coating.

7. The method of claim 6, wherein the mold inhibitor comprises propionic acid.

8. The method of claim 1, wherein the polymer film comprises about 0.1 wt % to about 5 wt % of the mold inhibitor.

9. The method of claim 1, wherein the feed product does not include the mold inhibitor or another mold inhibiting agent.

10. The method of claim 1, wherein the feed product includes pellets or extruded nuggets for livestock, horses, deer, or domestic pets.

11. A method of inhibiting mold growth within a bag for a feed product, the method comprising:
adding the feed product to the bag, wherein the feed product is added at an elevated temperature and an elevated moisture level;
sealing the bag containing the feed product at the elevated temperature and the elevated moisture level; and
allowing the feed product to cool and release moisture within the bag,
wherein the bag comprises a mold inhibitor embedded within or applied to an inner layer thereof,
wherein at least about three weeks after adding the feed product to the bag, no mold growth is observed within the bag.

12. The method of claim 11, wherein the mold inhibitor comprises calcium propionate.

13. The method of claim 12, wherein the elevated temperature ranges from about 80° F. to about 150° F.

14. The method of claim 12, wherein the elevated moisture level ranges from about 11 wt % to about 13 wt %.

15. The method of claim 11, wherein the feed product comprises pellets or extruded nuggets.

16. A bag for a feed product, the bag comprising:
a bag material formed into two or more sheets joined together to form a cavity configured to receive the feed product, each sheet comprising:
a multi-layered substrate; and
a polymer film comprising calcium propionate, the polymer film lining an interior surface of the cavity.

17. The bag of claim 16, wherein the calcium propionate is embedded within the polymer film.

18. The bag of claim 16, wherein the calcium propionate comprises a coating adhered to a surface of the polymer film.

19. The bag of claim 16, wherein the multi-layered substrate comprises:
a film extrudate comprising biaxially-oriented polypropylene, wherein the film extrudate serves as an outermost layer of the bag material relative to the cavity; and
a fabric comprising woven polypropylene.

20. The bag of claim 16, wherein the polymer film comprises about 0.1 wt % to about 5 wt % of the calcium propionate.
